(19) United States
(12) Patent Application Publication
(10) Pub. No.: US 2008/0086370 A1
(43) Pub. Date: Apr. 10, 2008

(54) Environmental services broker for mediating collaborative computing sessions

(75) Inventors: Chandrasekhar Narayanaswami, Wilton, CT (US); Mandayam Raghunath, Bangalore (IN); Marcel-Catalin Rosu, Ossining, NY (US)

Correspondence Address: MICHAEL BUCHENHORNER, P.A., 8540 SW 83 STREET, SUITE 100, MIAMI, FL, 33143, US

(73) Assignee: International Business Machines Corporation, Armonk, NY (US)

(21) Appl. No.: 11/544,107

(22) Filed: Oct. 6, 2006

(51) Int. Cl. G07G 1/14

(52) U.S. Cl. 705/14

(57) ABSTRACT

A method for establishing symbiotic relationships between at least one mobile computing device and at least one stationary computing device, includes steps of: interacting with a computing entity assigned to an area where the at least one mobile and stationary computing devices are located using at least one networking protocol; receiving software modules from the computing entity, each one customized for the at least one mobile computing device for establishing the symbiotic relationships between the at least one mobile computing device and the at least one stationary computing device; running the software modules to interact with the at least one stationary computing device and the computing entity to establish symbiotic relationships that enable the performing of tasks selected by the at least one mobile computing device. The steps may be executed automatically upon receiving a trigger selected from a group consisting of: the at least one mobile computing device entering a designated location; an action of a mobile device user; a pre-selected preference of the mobile device user; and a time event.

### CROSS-REFERENCE TO RELATED APPLICATIONS

Not applicable.

### STATEMENT REGARDING FEDERALLY SPONSORED-RESEARCH OR DEVELOPMENT

The invention described herein was funded in part by a grant from the Republic of Korea, Institute of Information Technology and Assessment (IITA), and in part by Korea Ubiquitous Computing Lab (UCL). The government of the Republic of Korea may have certain rights under the invention.

### INCORPORATION BY REFERENCE OF MATERIAL SUBMITTED ON A COMPACT DISC

Not Applicable.

### FIELD OF THE INVENTION

The invention disclosed broadly relates to the field of mobile computing devices and more particularly relates to the field of ubiquitous collaboration architecture for mobile devices.

### BACKGROUND OF THE INVENTION

Handheld communication devices, especially when endowed with a programmable computing engine and connectivity, allow users to work and enjoy pastime activities while on the move. These mobile devices are portable, private, and easy to purchase. As computing power and telecommunications range increase, the functionality of the mobile devices also increases. A cellular phone that only twenty years ago was considered on the cutting edge of technology because it allowed a user to make and receive phone calls without a land line connection now has capabilities for web browsing, e-mail, calendaring, photography and shooting videos (in addition to making and receiving calls, of course). In 2005 in the country of Chile, with a population of 16 million people, there were 9 million cell phones in use. Taking into consideration that the total population figure includes young children, the elderly, and the poor, one could conclude that just about every adult in Chile who could afford a cellular phone owned one.

The popularity and utility of mobile devices is apparent. However, handhelds today still face distinct limitations. They must be small and lightweight enough for users to carry them, yet size restrictions place a limit on the size of their display screens and number of buttons or dials. Voice-based interfaces cannot always solve these problems because handheld use often occurs in public places where noisy environments interfere with voice commands. Further, for the time being, powerful handhelds will be restricted by their relatively short battery life. Given these limitations, we can reasonably ask whether handheld usage will continue to proliferate in the near future. It seems that connectivity, better I/O capabilities, and CPU power offset the larger size of these laptops. At the other end of the spectrum, wearable computers or even body-implanted computers could replace handhelds if these alternatives become easily available and safe; just as pagers, which were so commonplace in the 1980s, were replaced by the more functional cellular phones.

Biomimicry (from bios, meaning life, and mimesis, meaning to imitate) is a newly-formed field of scientific thought that studies natural processes and designs and then mimics those designs and processes to solve human problems. Studying a leaf to invent a better solar cell is an example. Biomimicry focuses on how non-human communities in nature evolve and adapt to their environment. These communities, although immensely varied, all have one thing in common—they are limited in their adaptations by the confines and constraints of their environment. The successful communities are those that maximize long-term sustainability by closely following natural laws. To predict the future of handhelds, we borrow some ideas and models from biology and model our current computational environment on a jungle model where multiple device types compete for (market) survival. As in nature, the fittest devices rapidly increase their presence and succeed. In this modern-day jungle, success is measured by how useful humans perceive a device to be.

In nature, organisms pursue many different survival strategies, but we will explore only one survival mechanism that biological organisms use: symbiosis. Initially defined by Anton de Bary in 1879, symbiosis describes a mutually beneficial relationship between dissimilar organisms. Normally, we can distinguish three types of symbiotic relationships: 1) mutualism, in which all organisms benefit from their relationship to each other; 2) commensalisms, in which one organism benefits with minimal cost or benefit to the others; and 3) parasitism, in which the benefits that one organism derives come at a cost to all others. Common usage treats the term commensalism as a synonym for symbiosis, even though symbiosis refers to the entire continuum of symbiotic relationships.

Developers of handhelds have already explored symbiosis to overcome some limitations. Referring now to FIG. 1 there is shown a simplified depiction of a typical architecture for a tech user's computing environment. In this environment the user has three commonly-used mobile devices: a cellular phone 170, a laptop 160 and a personal digital assistant (PDA) 150. The commensal relationship between the PDA 150 and the laptop computer 160 offers a classic example. The laptop's full-size keyboard and large display simplify the management of data and applications on the linked PDA 150. The linked relationship is depicted by the dashed line. The synchronization process between the two devices simply and safely backs up the PDA's 150 data. In addition there are other advantages, such as ease of use and application availability. Symbiosis with personal computers gave PDAs a clear competitive advantage over simpler electronic address books, rapidly pushing these rivals toward extinction.

As FIG. 1 also shows, the laptop 160 and the cellular phone 170 both have internet access and can traverse the world wide web (shown here as a server farm) 130 through the internet 120. The PDA 150 is linked to the laptop 160 so that it can synchronize calendars, contacts, e-mails, and the like, with the laptop 160. A user of this environment 100 would typically use the laptop 160 at work and then take it home to continue working or keep up with e-mail. The user would also typically travel with the laptop 160 on business trips in order to maintain contact with his co-workers and to keep up with work assignments while traveling. The cellular phone 170 is a mobile device that tends to be the most ubiquitous of all. And now smart phones, which implement the cell phone and PDA functionality in the same device are becoming increasingly popular.

Although as stated earlier PDAs and laptops enjoy a symbiotic relationship, just as in biology, the relationship is limited by the constraints imposed by their environment. The PDA 150 is limited by its relatively short battery life, small display area and less than ergonomic keypad. A laptop 160 is limited by its short battery life, its dependence on AC power, and although a laptop 160 is portable, it is not as small and lightweight as a handheld device.

WiFi (Wireless Fidelity) Cafés address part of the problem of providing services for mobile devices. WiFi Cafés are internet hotspots housed in “friendly” business establishments such as cafés. These hotspots provide a wireless infrastructure, often for free, to customers and locals. A wireless-enabled laptop can access the WiFi network of the café during the time the person is within range of the hotspot. The popularity of these WiFi Cafés has prompted wireless businesses to implement Internet “Hot Zones.” Internet. Hot Zones are larger wireless infrastructures spanning neighborhoods, generally in busy metropolitan retail districts. In May of 2004, AnchorFree, a provider of wireless services, expanded the Hot Zone to include an entire city by transforming downtown Palo Alto, Calif. into one of the first Wi-Fi Hot Zones in America. Locals and visitors in Palo Alto are able to access the Internet anywhere in downtown Palo Alto (both indoors and outdoors). Unarguably, consumers are asking for, and receiving, more “on-the-go” capabilities for their wireless devices in their quest for an interconnected lifestyle. Hotspots and hot zones have filled a need in the mobile device marketplace. Still, the hotspots and even the broader hot zones are limited to providing wireless connectivity only. There remains a need for an environment which can provide a broad range of services to users of mobile devices, not just internet access.

For these and other reasons described above, there is a need for a more comprehensive mobile device architecture to overcome the shortcomings of the prior art.

### SUMMARY OF THE INVENTION

Briefly, in accordance with a preferred embodiment of the invention, a method for establishing symbiotic relationships between at least one mobile computing device and at least one stationary computing device, includes steps of: interacting with a computing entity assigned to an area where the at least one mobile and stationary computing devices are located using at least one networking protocol; receiving software modules from the computing entity, each one customized for the at least one mobile computing device for establishing the symbiotic relationships between the at least one mobile computing device and the at least one stationary computing device; running the software modules to interact with the at least one stationary computing device and the computing entity to establish symbiotic relationships that enable the performing of tasks selected by the at least one mobile computing device. The steps may be executed automatically upon receiving a trigger selected from a group consisting of: the at least one mobile computing device entering a designated location; an action of a mobile device user; a pre-selected preference of the mobile device user; and a time event.

In accordance with an embodiment of the present invention, an environmental services broker provides computing services to a plurality of mobile devices. The environmental services broker includes: a memory for storing program code therein; a processor, operatively connected to the memory, for carrying out instructions according to the stored program code; wherein the program code, when executed by the processor, enables the processor to: register each of the computing services; handle queries from the mobile devices; and set up and tear down sessions between the mobile devices and the computing services. The processor also manages a workload between the plurality of mobile devices and the computing services and controls access to the computing services such that unauthorized users are restricted from accessing the computing services. The environmental services broker also includes an input/output subsystem for mapping input/output controls from the mobile devices to the computing services.

Also in accordance with an embodiment of the present invention, a device resident agent includes an interface for providing a user with information about a service zone. A service zone includes a plurality of computer-based services stored in the same geophysical location. The information provided to the user may include: information about the location of the service zone relative to a mobile device; information about services available at the service zone located within range of the mobile device; duration of the services provided; and a cost for the service provided, if applicable.

A method for providing computing services to a plurality of mobile devices includes steps or acts of: receiving an indication that a mobile device is within range of an entity providing the computing services; receiving a query form the mobile device; setting up a session for enabling the mobile device to utilize the computing services provided by the entity, wherein the mobile device and the computing services are participants of the session, and wherein the session comprises associations indicating relationships among the participants of the session; and managing the session.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a simplified illustration of a basic mobile device system architecture, according to the known art.

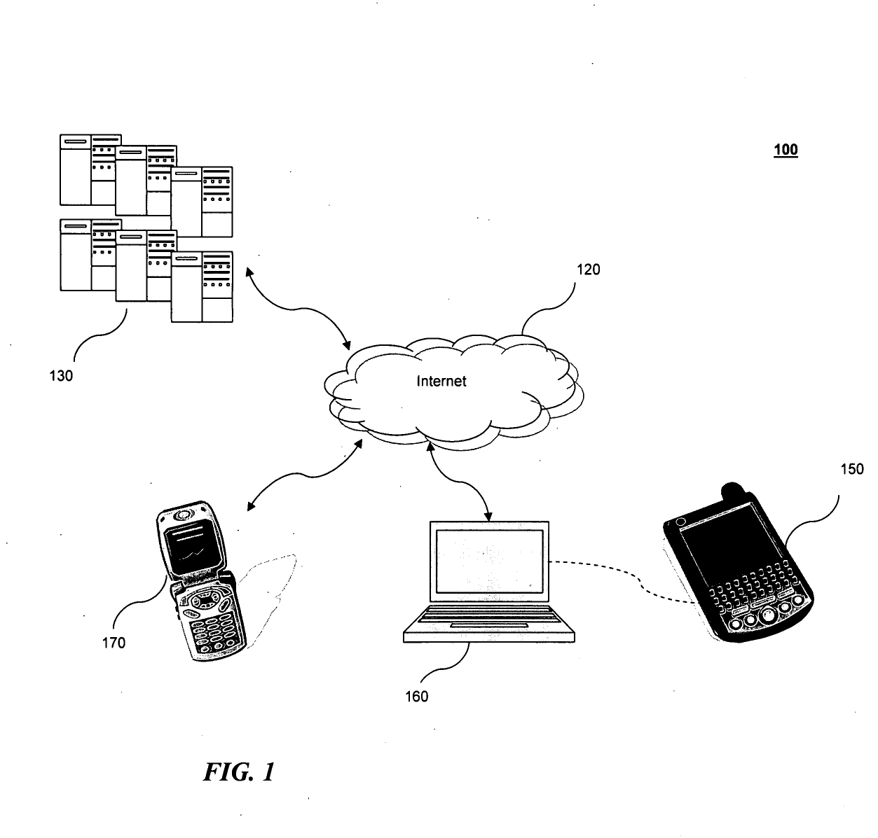

FIG. 2 is a high level architectural diagram showing an ubiquitous collaboration system architecture, according to an embodiment of the invention.

FIG. 3 is a high level block diagram of an Environmental Services Broker, according to an embodiment of the invention.

FIG. 4 is a high level block diagram showing the functions of an environmental services broker according to an embodiment of the invention.

FIG. 5 is a flowchart illustrating the collaboration process from the perspective of the mobile device, according to an embodiment of the invention.

FIG. 6 is a flowchart illustrating the collaboration process from the perspective of the Environmental Services Broker, according to an embodiment of the invention.

FIG. 7 is an illustration of a PDA shown with a list of services offered, according to an embodiment of the present invention.

FIG. 8 is a high level block diagram of an information processing system configured to operate according to an embodiment of the present invention.

FIG. 9 is a simplified illustration of a mobile device with an embedded agent supporting the Rich Client Platform, according to an embodiment of the present invention.

### DETAILED DESCRIPTION

We describe a system to facilitate the creation and management of symbiotic relationships between one or more mobile devices and one or more environmental services (i.e., services offered by environmental devices). These environmental services may include: high resolution display services, computational offload services, transportation scheduling services, product review services, and many more. By establishing symbiotic relationships between mobile computers and environmental computing devices, users receive the advantages of mobile computing devices such as the portability, sole ownership, and privacy as well as the advantages of the richer set of capabilities of non-mobile environmental devices such as larger display sizes, access to abundant resources such as computing power and energy, and faster network communication.

Establishing such symbiotic relationships in a seamless fashion, as and when required (on demand), to a multitude of different users with differing needs in a variety of settings is a difficult challenge addressed by ongoing work in the field of pervasive computing, also known as ubiquitous computing, or ubicomp. Pervasive computing is the next generation computing environment making information and communication technology available everywhere, for everyone, at all times by embedding computing into existing human systems. As an example, IBM is working with distributed display surfaces called “Blue Boards” that, combined with wireless technology, allow users to access personal content anywhere and anytime.

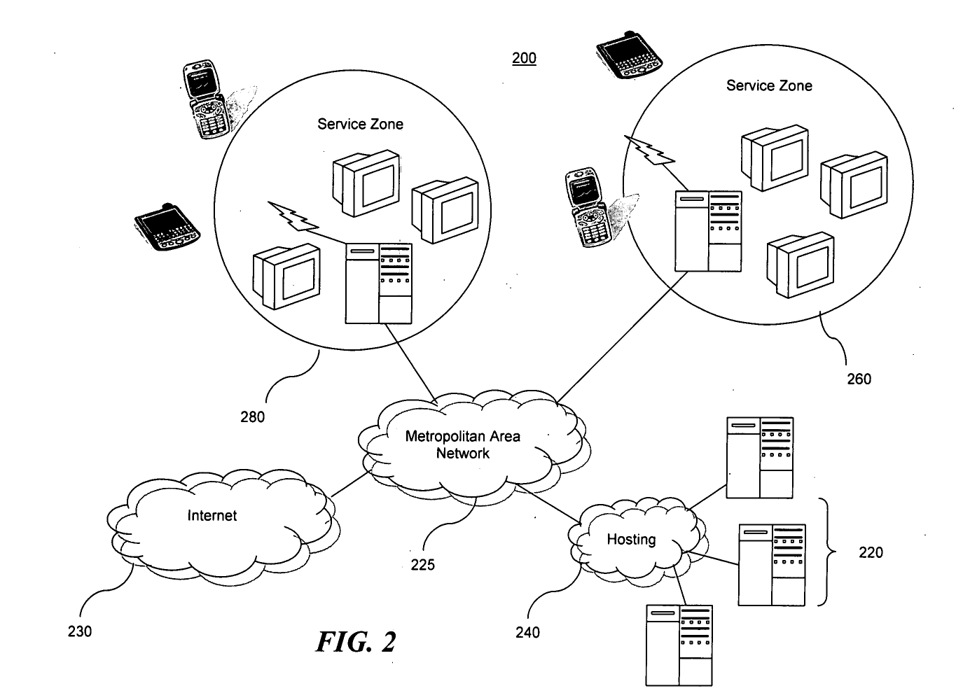

Referring to FIG. 2 there is shown a ubiquitous computing environment 200 including Environment Services Brokers, according to an embodiment of the present invention. The system 200 of FIG. 2 includes a Metropolitan Area Network (MAN) 225, and a hosting center 240 including three remote Environmental Services Brokers 220. Two service zones, 260 and 280, are shown, each with its own Environmental Services Broker A service zone is a physical public space where several environmental services are available for use by mobile devices. Examples of such spaces may be a meeting room, a train/bus or other transportation vehicle, a shopping mall, a bus station, a section of an airport, and so on. Generally service zones are located in public areas that experience a high density of mobile users, for at least a significant portion of the day. The MAN 225 and the Hosting Center 240 are connected to the Internet 230.

Environmental Services Broker. Central to the environment of FIG. 2 is the Environmental Services Broker 220. An Environmental Services Broker (ESB) 220 is a special kind of environmental service that is aware of the other environmental services available in a particular zone and manages the use of these services, making them available to mobile devices that visit the zone (are in range of the zone). The ESB 220 is configured to provide services that are customized to its service zone, taking into consideration the location of the zone, and the device configurations within the zone. Such customized services may include media transcoding services which are characteristic of the device capabilities in the zone.

The ESB 220 can be aware of the other environmental services through the use of location-aware applications. The ESB 220 may also carry out some of the requested environmental services. The ESB 220 is essentially a machine offering a collection of services to the mobile devices that transit a service zone. It facilitates the creation and management of symbiotic relationships between one or more mobile devices and one or more environmental services and also helps manage the other services that are deployed in the zone. Managing the services includes authenticating the mobile devices transiting the zone, maintaining a registry of the services available in the zone, some of which are offered by the mobile devices, controlling access and metering access to these services. Each service zone is managed by an ESB and the ESB may either be resident in the zone itself, such as for zones 260 and 280, or housed at a remote hosting center, such as the Hosting Center 240. An ESB could also be responsible for multiple service zones. In this way the reach of the ESB is easily extended rather than adding additional ESBs for every additional service zone.

Additionally, an ESB could delegate its services to another processor if that is what is necessary to accommodate the requirements of the service zone. Note that even though an ESB in this scenario is not performing all of the broker services itself, it is still managing the service zone.

Service Zones. The system 200 shows two service zones, 260 and 280. A service zone is a physical space where several environmental services are available for use by mobile devices. Examples of such spaces may be a meeting room, a bus/train station, a section of an airport, a train/bus or other transportation vehicle, and the like. Each zone may offer several environmental services, examples of which include high resolution display services, high speed wireless network connectivity services, and computation offload services. The service zones 260 and 280 include computing power with a network interface, high-speed wireless connectivity and an Everywhere Interactive Display (EID). The EID is a steerable projector equipped with a motion-detecting web cam. These are just some examples of the services offered in service zones. Mobile devices such as the PDAs and cell phones shown in FIG. 2 can access the computing power of the service zones 260 and 280 through a wireless connection, such as Wi-Fi or Bluetooth. Service zones can be implemented in just about any location equipped with environmental devices and are configured to accommodate a wide variety of devices, with multiple interconnection technologies and types of services. A service zone can scale from a small service zone with one or two environmental devices, such as in a bus station, to hundreds of devices in a large zone, such as a major train station.

Infrastructure. The networking infrastructure of the environment 200 accommodates existing interconnect technologies and is designed to accommodate emerging technologies. As such, the infrastructure is scalable. The backbone of a service zone is preferably an IP LAN implemented using switched 100/1000 Mbps Ethernet. Access points for available wireless communication technologies, such as WiFi, Bluetooth, and IrDA (Infrared Data Association), are connected to the LAN. All these access points are configured in bridging mode. As a result, Bluetooth-connected clients can communicate seamlessly with WiFi, IrDA or wired Ethernet-connected mobile or environmental devices, or with Bluetooth-connected devices on a different piconet (a network of devices connected in an ad hoc fashion using Bluetooth technology). This is an example of using off-the-shelf products to provide a robust solution to assuring interoperability between mobile devices with different connection technologies.

The design of the architecture 200 makes every attempt to be independent of the networking technologies, hardware platforms, operating systems, runtime frameworks and programming languages used for its initial implementation. However, given the self-describing nature of XML (extensible Markup Language) documents, including web service interfaces and messages, and the growing popularity of web service technologies, for now it is desirable to use web services for inter-device communication and other open, XML-based standards for describing device capabilities and other elements of the architecture 200.

Users should also be provided with adequate security and privacy guarantees. Adequate safeguards must be in place to ensure that the information exchanged between a user's mobile device and the environmental services are protected from various kinds of attacks. There should be a way for environmental services to certify to the users that they will protect the confidentiality of the information they receive from the mobile devices, and also a way for the mobile devices to transparently validate these certifications without explicit involvement of the users of the mobile devices. Well-tested cryptographic technologies, such as SSL are used to protect the communication between client and broker from attacks. A client agent on the mobile device can automatically authenticate the device to the broker using standard account/password techniques or directly, by using SSL connections configured with client authentication.

In order to realize the vision of such a wide-spread deployment of services, the architecture needs to ensure that the entry barrier to deploying such a service zone is low. In addition the service zone should be immediately accessible and usable by a wide range of mobile devices already in existence. Further, once deployed, a service zone should be easy to manage and administer. As newer devices are introduced in the market, and newer services are developed, it should be easy to roll out support for these to existing zones. The administrative cost of managing such roll-outs should be minimal. Towards these goals, service zones should be adequately equipped with equipment for remote testing of existing and newly deployed services and for intelligently monitoring and reporting problems that mobile users experience. The ESB 220 could conduct the monitoring and testing.

Since service zones are in public spaces, service providers may have to procure licenses for operation and abide by local regulations. Compliance could include maintaining a secure log with the identity of the individuals utilizing services, ensuring that standards of decency are maintained, such as disallowing viewing of content suitable only for mature audiences, providing zone services without discrimination, documenting zone quality and user satisfaction and obtaining a certified rating from a local governing body, and so on. This collection of stringent requirements mandates incorporating as many proven technologies as possible into the service zone architecture and its implementations.

For simplicity and clarification, FIG. 2 is shown with only a few environmental devices and two service zones. The environment 200 as shown is easily extensible to support more than two service zones.

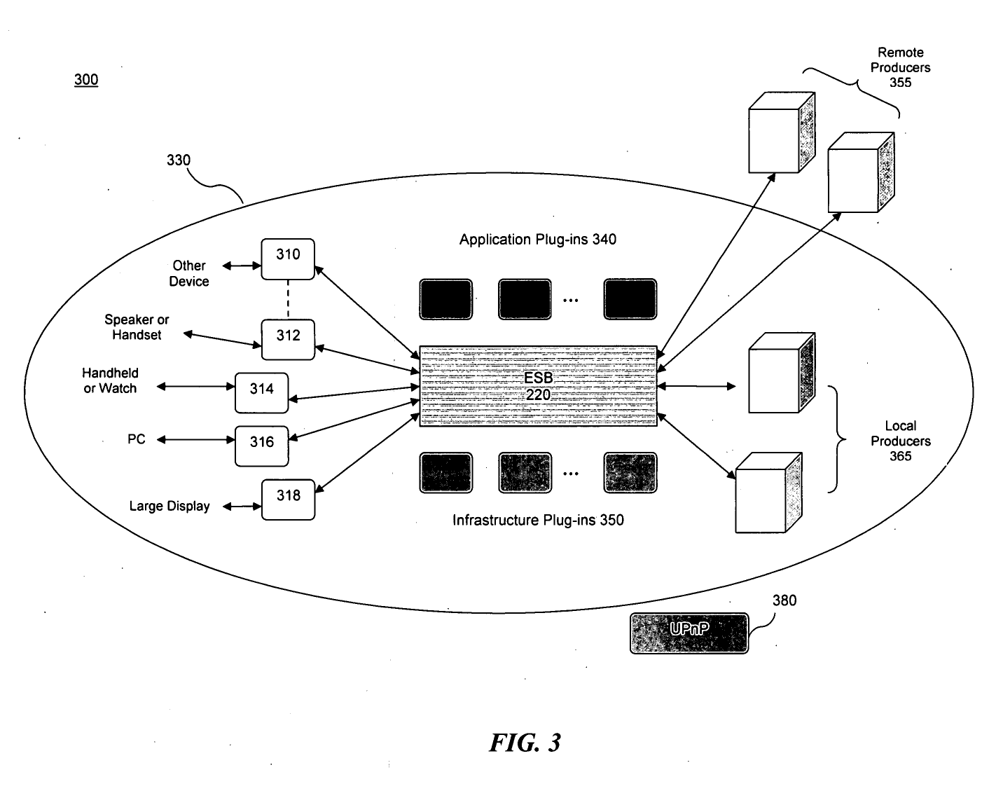

FIG. 3 shows ubiquitous collaboration system architecture 300, according to an embodiment of the invention. The ESB 220 in this example is shown as a single device such as a server. In actuality, the ESB 220 may be any computing system or even program code stored in a computing system. Local Producers 365 are devices within the zone that host services, such as an intelligent display or a thermostat accessible across a wireless connection. Remote producers are Internet sites that provide services, such as amazon.com which provides a web services-based interface for shopping. A large collection of plug-ins is used to customize the ESB to the requirements of the zone and its users. Roughly, the plug-ins are either Application plug-ins 340, which enhance the application-level functionality of the devices (fixed or mobile) in the zone or even that of the ESB 220 when viewed as a device providing application-level services, or Infrastructure plug-ins 350, which enhance the ability of the ESB 220 and zone devices to interact with each other in an efficient (secure, scalable, maintainable, cost-efficient) manner. This system 300 also includes an UPnP™ (Universal Plug and Play) gateway 380 to accommodate UPnP™ clients. UPnP™ uses standard TCP/IP protocols and can be supported on most operating systems. It offers pervasive peer-to-peer network connectivity of PCs of all form factors, intelligent appliances, and wireless devices. Some of the services available in the service zone 330 are: large display 318, PC 316, handheld or watch 314, speaker or handset 312, and others 310. Some of these devices may need custom plug-ins to make them work well with the local ESB or directly with the mobile devices in the zone. These plug-ins are stored and managed by the ESB.

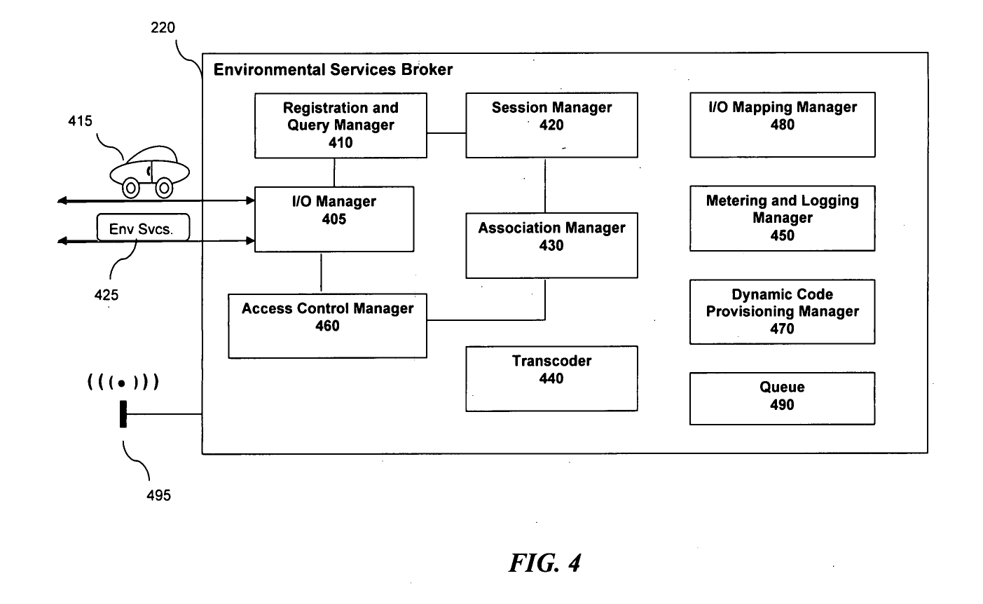

FIG. 4 shows the elements of the ESB 220. Note that these elements are logical constructs, defined here to illustrate the different functions of the ESB 220. All of the different aspects of the ESB 220 services can be installed on any computing device that is network connected and has adequate computing resources to perform these operations in an efficient manner. The ESB 220 services can be embedded into devices that are appropriate for the zone being managed. For instance, if the zone is in a user's home then the broker services may run on a set top box and manage the services offered by various large screen displays in the home, personal computers in the home and the like. Wireless access points are also suitable devices where the broker services may be embedded. Any device offering a service, such as a projector or a high resolution display, may host broker services so that other devices in the vicinity may register themselves with it.

Input/Output Manager 405: this element of the ESB 220 handles the interaction with the mobile devices 415 and the environmental services 425 hosted on environmental devices. All inputs and outputs to/from the ESB 220 are handled by the I/O Manager 405. Discovery and use of the services should be intuitive and readily apparent even to users who do not possess a high degree of technical skills; they should also be quick, as users may be only traversing the zone. In many scenarios, mobile devices can interact with environmental devices without the intervention of the user. The mobile device will attempt to get the attention of its owner only after it is determined that the user attention is desired or necessary. The architecture and its implementations are context aware, therefore they should be aware of the level of cognitive load they place on the users. It should be easy for users to express their intentions to their mobile device as well as to the environmental services. User annoyance as a result of devices seeking user attention unnecessarily should be minimized. Inside a zone, the mobile device should solicit the user attention based on the available services, user profile and context, such as time of day, day of the week, purpose of the trip, and based on who else is in zone—e.g., friends, family, and so on. As mobile users integrate usage of certain Celadon services into their daily routines, they will expect these services to be highly available (inside the zones) and exhibit predictable response times. These expectations will be enforced by their usage of cell phones as the preferred mobile device, which is typically associated with the highly available cellular service.

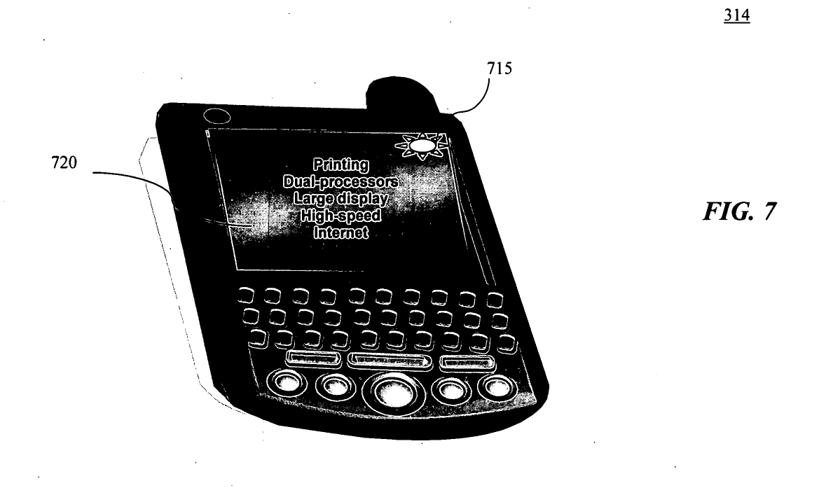

Registration and Query Manager 410: the ESB 220 provides a centralized registration service where different environmental services 425 register themselves with it and for mobile devices 415 to be able to query and learn about these services. When an environmental service 425 becomes available in a service zone, it must first register itself with the ESB 220. It must provide information on its address, capabilities and functionality. Similarly, mobile devices transiting the zone can register the services they host with the local ESB using the Registration and Query Manager 410. Mobile devices can query the broker to discover these services eliminating the need for complex protocols such as multicasts. The discovery of the ESB 220 itself is piggy-backed on the IP address assignment in cases where the mobile devices only have local connectivity. When a mobile device obtains a local IP address from the zone-local. DHCP server, we use a naming convention that enables the mobile device to find the location of the ESB 220 by performing a DNS lookup for ESB 220 in the assigned domain name. In cases where the mobile device has an IP address assigned by a DHCP server outside of the local service zone, the mobile device finds the ESB 220 using a DNS lookup for the name of the ESB 220 that manages the zone in question. For example, when a mobile device 415 enters a service zone, it first discovers the ESB 220 services and communicates with it to discover the other services that are present in the zone and also to discover the ones that are currently free and available for the mobile device 415 to use. The mobile device 415 can “discover” the ESB 220 services because it is equipped to receive radio frequency (RF) signals from at least one wireless access point assigned to the zone and connected over the LAN to the ESB 220, or directly from the ESB 220 if the ESB 220 is implemented in the access point device. When the mobile device 415 is within range of a service zone, it will pick up the RF signal characteristic to the service zone. The user of the mobile device 415 will be made aware of the signal by an LED (light-emitting diode), a beep or some other signal. If the user wishes to receive information about the services currently offered in this service zone, the user will acknowledge the signal. Referring to FIG. 7 there is shown the PDA 314 of FIG. 3 with an active LED 715 using IrDA standards, indicating communication from the ESB 220. The display, screen 720 shows a textual representation of the services available. Rather than a textual representation, the display might be generic icons corresponding to the different services. For example, a printer icon would resemble a printer, or a sheet of paper.

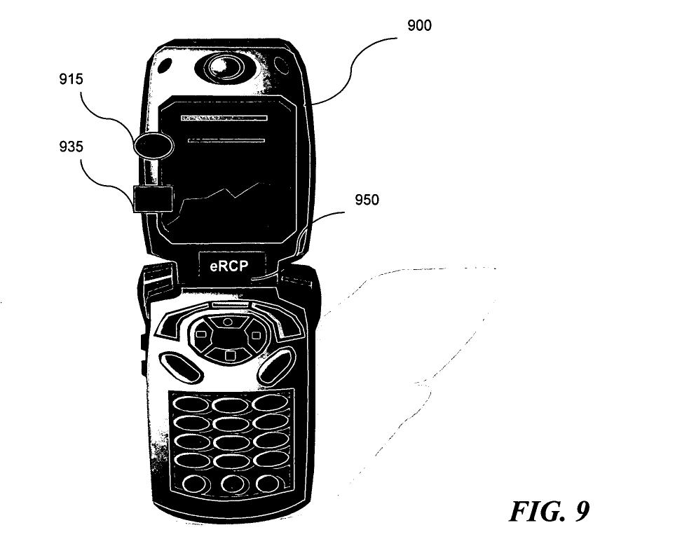

The PDA 314 might also be fitted with sensors and actuators to receive information about the services available. Once the signal is acknowledged by a mobile device 415, the ESB 220 transmits information about the services. FIG. 9 is a simplified illustration of a mobile device 900 with an embedded agent supporting the Rich Client Platform. The mobile device 900 contains embedded Rich Client Platform (eRCP) bundles, which are used for the user interface. These eRCP bundles act as an embedded agent, handling the communication between the mobile device 900 and the ESB 220. A sensors 915 and actuator 935 facilitates the communication between the device 900 and the ESB 220.

Session Manager 420: when the user of a mobile device 415 discovers that there are services in the zone that are of value to it, and that these services 425 are currently available as shown in FIG. 7, the user can request the ESB 220 to enable the device 415 to use these services 425. The ESB 220 then sets up a session where the services 425 are reserved for the requesting mobile device 415. Until the mobile device 415 has released the service 425, it will not be made available to another user. The ESB 220 also enables the mobile device 415 to remove services 425 from the session that was created. Session management also includes the operations required to tear down sessions (for example when the mobile devices 415 in a session leave the zone).

In a service zone, available services can be in use by multiple mobile devices. In a simple scenario, each mobile device uses one or more services independent of the other mobile devices. In a more complex scenario, there may be multiple users who wish to work collaboratively, sharing the environmental services amongst their own devices and exchanging data and control between their mobile devices as well as the environmental services. The owner of a mobile device 415 may wish to include the mobile devices of other users in the session. The ESB 220 facilitates this as well. When requested by a mobile device, the ESB 220 sets up a session where the requested subset of the zone services is reserved for the requesting mobile device. These services are usable only by the devices that are part of the session. The ESB 220 also enables the user of the mobile device to add or remove services from the session that was created.

In addition, the ESB 220 facilitates including the mobile devices of other users in the session, if the mobile user who started the session wishes to do so. This way the ESB 220 can support both the simple usage scenario, where there is a single mobile device that is using one or more of the services in the zone, and the more complex scenario where multiple users get together at a zone to share information. In the latter case, one of the mobile devices creates the session and then allows the other mobile devices to join the session. Active sessions are made apparent to any mobile device 415 within the zone by the ESB 220. To join a session, the user of the mobile device 415 may select a session based on off-channel information, such as verbal communication with other mobile device users in the same area. Once in the session, the devices have access to all of the services that have been reserved for that session. The actual coordination of the usage of these services is managed by way of associations that are described below.

The ESB 220 offers session management services, which provide the operations required to set up and tear down sessions, and to ensure that devices in different sessions are prevented from interfering with each other. In addition, the ESB maintains session ownership, which includes mediating the transfer of session ownership from one device to another. Session tear down may either be explicitly initiated when the owner of a mobile device decides to terminate a session that it owns, or when the mobile devices in a session simply exit the zone.

Association Manager 430: Within a particular session one or more mobile devices 415 may act as clients for the services 425 that have been reserved for that session. While some services 425 may be simultaneously usable by more than one client, some services 425 such as the use of display services such as an EID may support only one client at a time. The ESB 220 also manages the relationship between such single-use services and its clients. The management of such relationships is called association management. An association is a relationship between a service and the client that is authorized to use the service. An association is like a pipeline where you can send a message only in one direction at a time. There may be several associations within a session. Associations may be created and terminated several times within the same session. The ESB 220 manages associations, ensuring that devices in a zone can work together without interfering with each other. If a particular service can support only one client at a time, the ESB 220 ensures that the current association is terminated before creating a new one. As part of the association management, the ESB 220 also creates and distributes access control tokens to the service provider and the consumer of the service to ensure that unauthorized clients are prevented from accessing services that are not permitted. Access tokens are destroyed when the corresponding association is terminated.

Transcoder 440: The ESB 220 also provides conventional transcoding services to help perform syntactic transformation of data, if necessary, from the mobile devices 415 to the services 425. This is necessary when the mobile devices 415 use a different format than the format accepted by the environmental services 425. For example, an environmental display service 425 may be capable of displaying only Adobe® PDF and postscript formats, yet the mobile device 415 needs a display for a document in Microsoft Word. The transcoding service provided by the ESB 220 will transform the user's Word document into PDF or postscripts formats, so that the display service can display it to the user. Service providers may add their own transcoding services and could include language translation, or document format conversions, such as size and resolution reduction, color depth conversion, and the like, and make them available in the service zones.

Metering and Logging Manager 450: some environmental services 425 are made available on a pay per use basis, where the owners of the mobile devices 415 pay a certain usage fee to use these environmental services 425. Within a particular session one or more mobile devices may act as clients for the services that have been reserved for that session. Since the ESB 220 manages the set-up and tear-down of sessions and associations, it also logs the usage of the services and tracks their usage so that the mobile device owners can be billed for the usage of these services 425. Some environmental services are made available on a pay-per-use basis. Service providers may use existing payment mechanisms to allow users to enjoy pay-per-service facilities. The ESB 220 is also responsible for upgrades and installation of new capabilities, especially on mobile devices. The ESB 220 performs these responsibilities so that the mobile user does not have to.

Access Control Manager 460: the ESB 220 also manages the access permissions associated with the environmental services 425, which represent all services available in the zone. Although environmental services 425 are shown in FIG. 4 as being external to the ESB 220, in certain zones, some of these services are implemented as ESB plug-ins; note that the collection of environmental services is dynamic, as mobile services transiting the zone can host and register services they host. The Access Control Manager 460 authenticates a new device entering the zone and identifies the subset of environmental services 425 the new device is allowed to use, if any.

Dynamic Code Provisioning Manager 470: in many cases the mobile devices 415 may not have the appropriate code installed to use the services that are available in a particular service zone. The ESB 220 also maintains required client code for the services 425 that are under its purview and enables mobile devices 415 to download and run the client code so that the mobile devices 415 can use the services 425 that are available. Different mobile devices 415 may support different code execution environments (i.e., code containers) and the ESB 220 keeps copies of the client code for each such container and dynamically identifies and supplies the appropriate version of the client code that is suitable for the code container supported on the mobile device 415. The dynamic code provisioning aspect operates at a much finer granularity compared to the code provisioning that OSGi (universal middleware) or other similar software lifecycle management tools use. In the service zone architecture, mobile devices that enter a zone may come in without the code required to interact with the services in the zone. The requisite code is downloaded on demand into the mobile devices; when the mobile device exits the zone, and the downloaded code is no longer relevant, it may be deleted from the mobile device. This aspect of the architecture enables the deployment of mobile devices that require a minimum level of pre-installation or pre-configuration in order to use the services in the service zones. All that a mobile device needs is an environment into which code may be downloaded from and executed. When the device enters the zone, the device enters into a dialog with the ESB 220 to help the broker determine the type of code container that the device supports. The broker 220 then directs the device to download the appropriate code that matches the code container on the mobile device. Additional parameters that represent the context of the mobile device may be provided as part of this initial dialog so that the code that is downloaded to the mobile device can be customized to suit the context of the mobile device, such as its screen resolution or battery level, the ambient noise level, the users preferences, etc.

For dynamic code provisioning on mobile devices and environmental services and on the ESB 220, Service Management Framework (SMF), which is IBM's implementation of OSGi, is the preferred framework. SMF is a proven solution for dynamically managing the lifecycle of the software components in these devices. For environmental devices and the ESB 220, SMF helps reduce management costs. For mobile devices, SMF allows for context-aware on-demand provisioning of these resource-constrained platforms.

I/O Mapping 480: Some services may support control operations that can be sent to them from the mobile devices 415. For instance a high resolution display service may support zoom and pan operations. The I/O mapping function supported by the ESB 220 helps users find a way to use the I/O controls that are available on their mobile device 415 to generate the appropriate control operations required by the service. The ESB 220 maintains descriptions of various mobile device types and the types of I/O controls that are available on each device type. It also maintains a collection of mappings between the I/O controls and the service operations. When a user wishes to control a particular service with his mobile device 415, the ESB 220 searches through its mapping database and shows the user the possible ways in which his mobile device can generate the appropriate control operations and allows the user to choose one of the mappings. Once such a mapping is chosen, the user can generate the appropriate control operations by manipulating the controls on his device 415. The ESB 220 dynamically provisions code to the user's mobile device 415 that can capture the manipulation of the control signals, and maps these operations to the appropriate control operations that the service 425 understands.

Queues 490: The ESB 220 maintains queues for sessions waiting for a service 425 to become available. The ESB 220 sets up an association between such single-use services and the corresponding clients when requested and queues up requests from other clients so that the other clients wait until the current association is ended. When the current association is ended, the single-use service will be made available to the next client in the queue.

Network Access 495: An ESB 220 is typically connected to a LAN which has one ore more WiFi or Bluetooth access points connected to it as well. Mobile devices talk to the access points which communicate with the ESB 220 over the LAN (or the LAN+MAN for remotely located ESBs). The ESB 220 can be equipped with a wireless interface for those situations when the ESB 220 is also performing as a wireless access point for the zone.

All of the different aspects of the ESB 220 service can be installed on any computing device that is network connected and has adequate computing resources to perform these operations in an efficient manner. The ESB 220 service can be embedded into devices that are appropriate for the zone being managed. For instance if the zone is in a user's home the ESB 220 service may run on a set top box and manage services offered by various large screen displays in the home, personal computers in the home. Wireless Access Points (WAPs) are also suitable devices where the ESB 220 service may be embedded. In an embodiment of the present invention, the ESB 220 can be linked to, and share space with, Internet Hotspots, providing an excellent symbiosis between the WiFi capabilities of the currently available Internet Hotspots and the broader range of services offered by the ESB 220. In fact, any device offering a service such as a projector or a high resolution display may host the ESB 220 service so that other devices in the vicinity may register themselves with it. The ESB 220 should have ample storage used for its own programs and plug-ins, the code that it dynamically provisions to mobile devices, for storing metering and logging information, and so on.

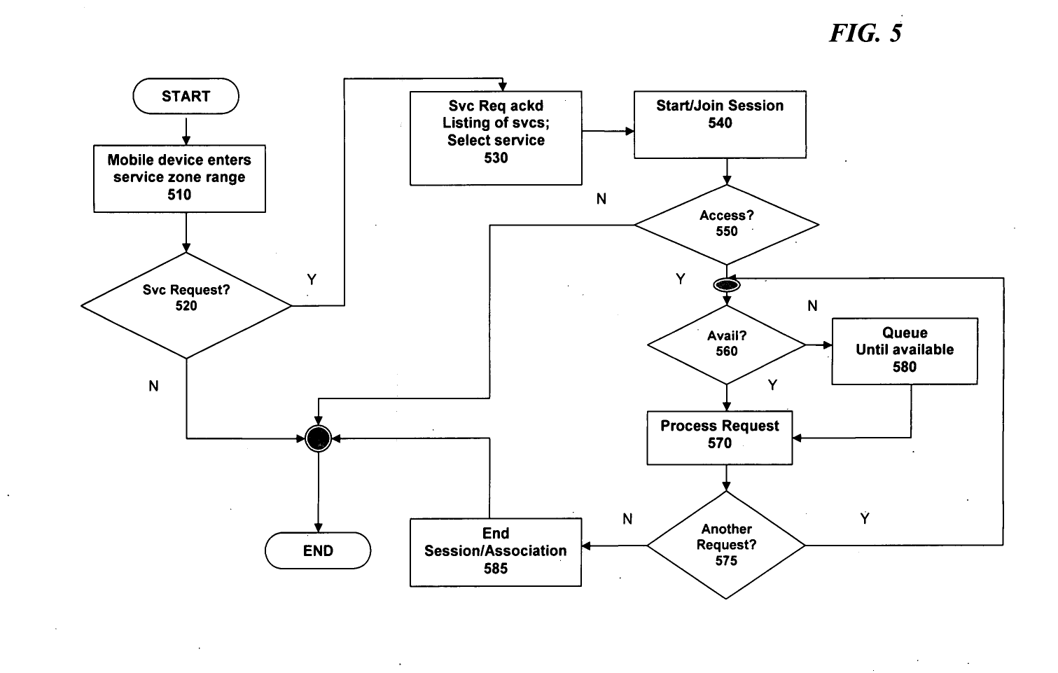

Referring to FIG. 5 there is shown a flowchart 500 illustrating an information processing method according to an embodiment of the invention. This method is shown from the perspective of the mobile device 415. The process begins at step 510 with a mobile device 415 entering a service zone range. The mobile device 415, once it is within range, receives an RF signal emitted by the ESB 220. The mobile device always acknowledges the RF signal. This is how mobile devices attach to an access point. During that process, which includes the exchange of more than one RF signal, it is determined if the mobile device 415 is allowed to attach to the access point. Once attached, the device can try to get a network address, which also requires multiple RF signals and link-level messages to be exchanged. The messages could be in the form of audio messages, visual messages, vibrations, or any other message type representative of the device in use.

Only after that, the mobile device 415 authenticates himself to the ESB 220. If the authentication is successful and if the user of the mobile device 415 is interested in accessing available services in the zone, the ESB 220 identifies itself to the device 415 at that point. The device 415 will then request the list of services available and accessible to it (based on the result of the device authentication step). Overall, there a lot of messages between the ESB 220 and the mobile device 415 until the list of services, if any, is provided to the device 415. Also, note that this list is only provided by the ESB 220 upon request.

Assume the mobile device 415 has authenticated itself in step 520. This indicates that the user is interested in an environmental service 425 offered at this service zone. Once the ESB 220 receives the acknowledgment from the user, it transmits a listing of currently available services. These are all of the services which have been registered in that service zone.

Once in receipt of the list of services, the user, by selecting a particular service, submits the query in step 530 to the Registration and Query Manager 410 (via the Input/Output Manager 405). Selecting a particular service may be as simple as clicking on a service listed on the user's display 720 as shown in FIG. 7. The ESB 220 starts a session to process the user's request in step 540. Also in step 540 a device can come into the service zone at this point and join an existing session. Next, in step 550 the ESB 220 creates an association for the requested service 425, which also includes the creation of access token for the mobile device to use when accessing this service. This access control token is then provided to the mobile device 415 and to the service 425 so that the service 425 can authenticate that the device 415 is authorized to use the service 425. It is up to the environmental service 425 to authenticate this access token. If an access control token presented by a mobile device is not valid, the environmental service 425 ignores the request and informs the ESB about the security violation. Every session must have an owner and the owner is the device with the access control token. A new device wishing to join an ongoing session must defer to the owner of the session and that owner can establish an association for the new device. If the owner of the session leaves the session before transferring the access control token, the session is terminated because it does not have an owner. This concept is analogous to a conference call situation where the call is terminated when the primary caller hangs up.

If the token is accepted, the mobile device 415 must query the Association Manager 430 (via the Input/Output Manager 405) if the device is currently available for use in decision 550. If the device is not available, in step 560 the mobile device 415 request is placed in a queue until the device becomes available. Once the device becomes available, in step 570 the request is processed and the mobile device 415 uses the services it needs. The mobile device 415 may invoke the service or any other service in the zone hosted by a device included in the same session multiple times. Therefore, if the mobile device 415 wishes to invoke another service in step 575, the processing loops back to step 560 where it is determined if the requested service is available.

Once finished with invoking the services in that session in step 575, the mobile device 415 signals to the ESB 220 that the session is ended. In step 585 the association between the mobile device 415 and the service 425 is terminated. If the departing mobile device 415 is the owner of the session then in step 585 the session is torn down and the process ends. Alternatively, the mobile device 415, as owner of the session, could simply exit the service zone and this will automatically trigger the ESB 220 to tear down the session. A departing device may choose to transfer the access token to a device just joining a session in order to keep the session going.

It is important to note that sessions are not established and terminated every time a mobile device 415 invokes a service. The same service, or the same collection of services can be invoked multiple times from within the same session. Sessions are modified when interactions with new devices are necessary, i.e., the new device(s) are added to the existing session or the mobile device 415 terminates its session and joins the ongoing session with which the desired devices are already associated. Sessions can be thought of as “non-overlapping groups of devices”.

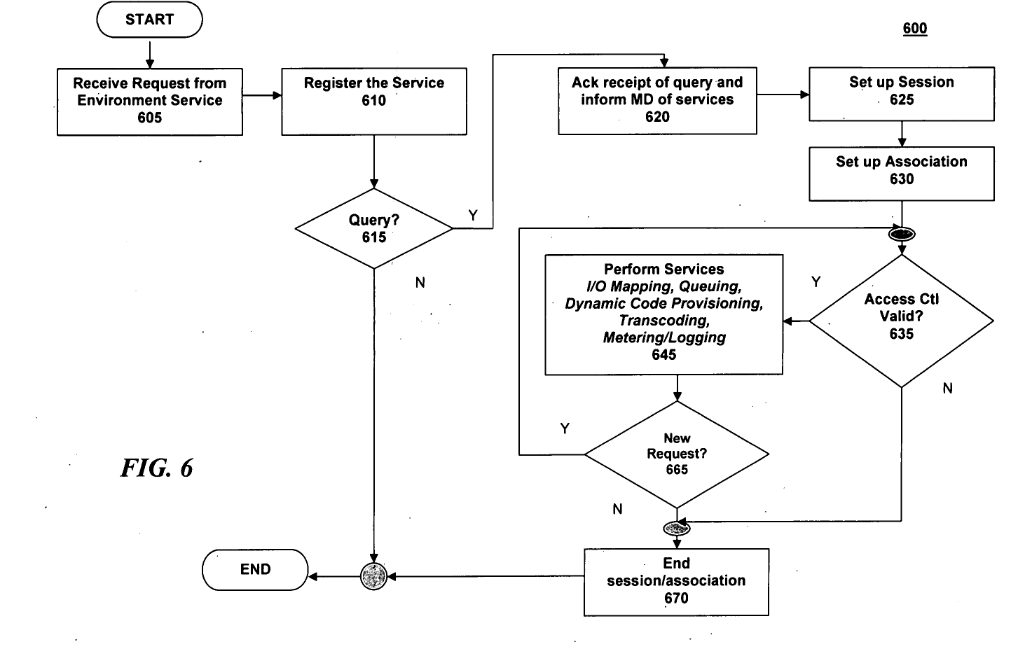

Referring to FIG. 6 there is shown a flowchart of the above process, but from the perspective of the ESB 220. The process begins at step 605 when the ESB 220 receives a registration request for an environmental service 425 in the service zone. Note that the service can be hosted either by an environmental device 425, in which case the registration request is issued when the environmental device 425 is installed in the zone, or by a mobile device 415, in which case the registration request is issued when the mobile device enters the zone. Service registrations are removed when the environmental device 425 is shut down, say for maintenance or upgrade, or when the mobile device 415 leaves the zone. At this point the ESB 220 must determine if it can effectively accommodate this service 425 or, if this service 425 does not conflict with an existing service or if it is even necessary or desirable (from a regulatory perspective) in this service zone. If so, the ESB 220 registers the service in step 610. Registering a service involves receiving information from the service, including the physical location of the service, its name, interfaces, capabilities, compatibility, limitations, and soundness

After the service is registered in step 610, the ESB 220 waits for other services to be registered or for a mobile device 415 to enter its service zone. When a mobile device 415 enters the zone it picks up the RF signals that are being constantly emitted by the wireless (WiFi, Bluetooth) access points connected to the ESB 220, or by the ESB 220 itself if the ESB 220 is implemented on the access point device. This is similar to the signals picked up by users entering a WiFi Hotspot. After authenticating the device, the ESB 220 receives a query for services in step 615 and then acknowledges receipt of the query in step 620. Additionally, at this time the ESB 220 informs the mobile device 415 of the services available to it in that service zone.

Next in step 625 the ESB 220 sets up a session and later an association between the device 415 and the service 425. Setting up the session involves creating a session ID, allocating the mobile device 415 and the device 425 hosting the service to the session and registering the new session in the registry. The mobile device 415 becomes the owner of the new session. Alternatively, as stated earlier, the device 415 can join an existing session if the service or services it wants to access are already assigned to a session. The mobile device 415 can join an existing session only with the permission of the owner of the existing session. Similarly, after the mobile device 415 joins an existing session, the ESB 220 will have to establish an association in step 630 between the mobile device 415 and the environmental service 425. At any time, the session owner can transfer the session ownership to another device in the session. This is necessary if the owner device leaves the zone but wants the session to continue.

Once the association is made in step 630, if the service 425 determines in step 635 that the access control token supplied by the device 415 is invalid, the environmental service 425 ignores the request and the ESB 220 is informed about the security violation. If the session is valid, the ESB 220 performs any intervention services needed by the mobile device 415 in step 645. The ESB 220 may determine that I/O mapping is necessary. If so, the mapping is done. It may be necessary to manage the queuing of the device 415 if the service is in use and/or at capacity. If dynamic code provisioning is necessary, it is done at this point. Likewise if transcoding is required, it is performed. If the session is a pay-per-service session, then the ESB 220 must perform metering and logging tasks. An alternative to a pay-per-service financial arrangement is a subscription service where a user pays a monthly fee. Another alternative is a no-contract debit card similar to phone service cards available today. A user would purchase a card for a set amount, enter the key code from the card into the mobile device 415 and would use the services 425 until the card zeroed out. These are just a few examples of the services performed by the ESB 220, and should not be construed as limitations to the scope of the capabilities of the ESB 220.

In step 670 the ESB 220 receives an indication from the service 425 that the association is ended. This indicates that the mobile device 415 has no further need of the environmental service 425. The session, however, is still ongoing until the owner of the session ends it. If, in step 665 the mobile device 415 wishes to use another service, it will loop back to step 630 and begin another association to partake of another environmental service 425. After the association is ended the process is complete until the next request is received, or until a new device enters the zone to participate in that existing session. If, however, the owner of the session wishes to terminate the session and/or leaves the zone, then in step 670 the session is torn down in order to make availability for a new session.

In another embodiment the ESB 220 provides services for multiple zones and these services are aggregated and run on a back-end network server that is physically far removed form the zone where the services are found. Aggregating the Environmental Services Brokering services and running them on a network server enables easy management and load balancing.

“Context refers to the physical and social situation in which computational devices are embedded. One goal of context-aware computing is to acquire and utilize information about the context of a device to provide services that are appropriate to the particular people, place, time, events, etc. For example, a cell phone will always vibrate and never beep in a concert, if the system can know the location of the cell phone and the concert schedule.” See Thomas P. Moran, IBM Almaden Research Center and Paul Dourish, University of California, Irvine, “Introduction to This Special Issue on Context-Aware Computing,” Special Issue of Human-Computer Interaction, Volume 16, 2001, which is fully incorporated by reference as if fully set forth herein. The ESB 220 is capable of managing context-aware provisioning of public services to the participants. Location-aware applications can be utilized to assist the services in conforming to a participant's surroundings.

A further advantage of the ESB 220 and the infrastructure in which it operates is its scalability. Because it operates within a wireless infrastructure, the entire system can be extended by simply adding more services or even by the addition of another LAN with its own ESB 220 and its own selection of services.

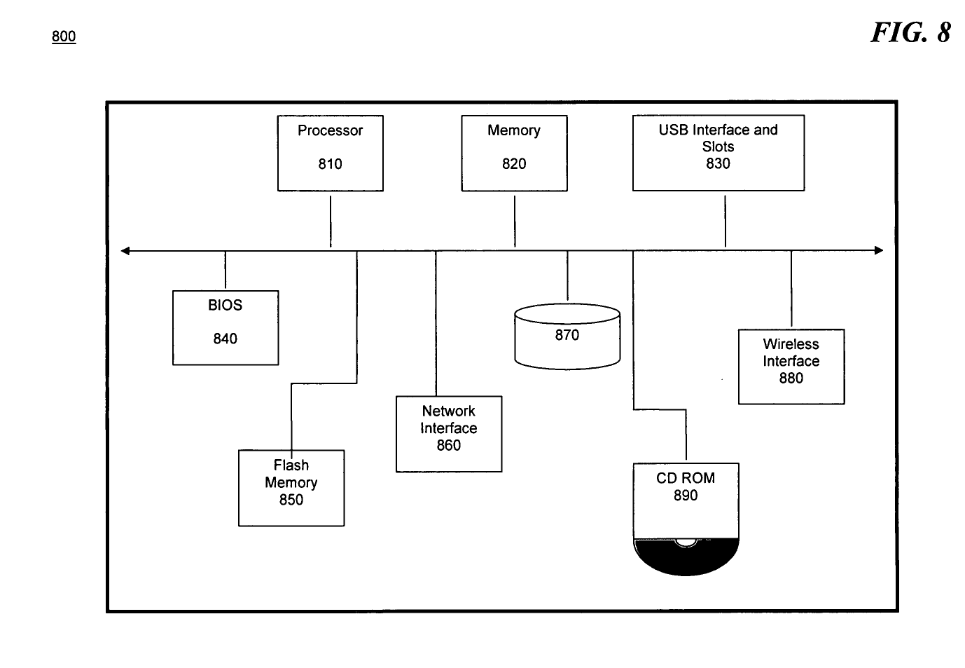

Referring to FIG. 8 there is shown a high-level block diagram of a computing system configured to operate according to an embodiment of the invention. The system 800 includes a Processor 810 which may include several microprocessors. It also includes Memory 820, a USB Interface and slots 830, a BIOS 840, Flash Memory 850, a Network Interface 860, Mass Storage 870, Wireless Interface 880 and a CDROM 890. A UPnP (Universal Plug and Play) resides in the software operating system.

Therefore, while there have been described what are presently considered to be the preferred embodiments, it will understood by those skilled in the art that other modifications can be made within the spirit of the invention.

We claim:

1. An environmental services broker for providing computing services to a plurality of mobile devices within a zone, the environmental services broker comprising:
a memory for storing program code therein;
a processor, operatively connected to the memory, for carrying out instructions according to the stored program code; wherein the program code, when executed by the processor, enables the processor to:
register each of the computing services;
handle queries from the mobile devices;
set up and tear down sessions between the mobile devices and the computing services;
manage a workload between the plurality of mobile devices and the computing services;
control access to the computing services such that unauthorized users are restricted from accessing the computing services; and
an input/output subsystem for mapping input/output controls from the mobile devices to the computing services.

2. The environmental services broker of claim 1 wherein the program code further enables the processor to provide computing services that are customized to the zone, such as media transcoding services characteristic to display drivers within the zone.

3. The environmental services broker of claim 1 wherein the program code further enables the processor to provide specialized code to the mobile devices in order to facilitate interaction between said mobile devices and the computing services, including enabling the processor to delegate the provision of the specialized code to another processor operatively configured to provide the specialized code.

4. The environmental services broker of claim 1 wherein the program code further enables the processor to provide metering and logging services comprising:
managing financial considerations of the sessions between the mobile devices and the computing services;
upgrading software for the mobile devices as needed to facilitate interaction between the mobile devices and the computing services; and
monitoring performance of the computing services.

5. The environmental services broker of claim 1 wherein the environmental services broker is realized as program code stored in at least one computing device.

6. The environmental services broker of claim 1 further comprising a wireless interface, such as a wireless access point.

7. The environmental services broker of claim 1 wherein the program code is further configured to provide context-aware provisioning of computer-based services to the mobile devices.

8. The environmental services broker of claim 1 wherein the processor is further configured to provide services to different zones

9. The environmental services broker of claim 1 where the services are aggregated and run on a back-end network server that is physically far removed from the zone where the services are found.

10. A device resident agent comprising:
an interface for providing a user with information about a service zone wherein a service zone comprises a plurality of computer-based services stored in the same geophysical location; wherein the information provided to the user comprises:
information about the location of the service zone relative to a mobile device;
information about the computer-based services available at the service zone located within range of the mobile device;
a duration of the computer-based services provided; and
a cost for the computer-based services provided.

11. The device resident agent of claim 10 wherein information about the service zone is conveyed by providing a message to the user or a user agent of the mobile device when the mobile device is within range of the service zone.

12. The device resident agent of claim 10 further comprising a UPnP interface for interacting with a UPnP device.

13. The device resident agent of claim 10 wherein the interface further provides context-aware provisioning of the computer-based services.

14. The device resident agent of claim 10 further comprising embedded rich client platform bundles.

15. A method for providing computing services to a plurality of mobile devices, the method comprising steps of:
receiving an indication that a mobile device is within range of an entity providing the computing services;
receiving a query from the mobile device;
setting up a session for enabling the mobile device to utilize the computing services provided by the entity, wherein the mobile device and the computing services are participants of the session, and wherein the session comprises associations indicating relationships among the participants of the session; and
managing the session.

16. A method for establishing symbiotic relationships between at least one mobile computing device and at least one stationary computing device, the method comprising steps of:
interacting with a computing entity assigned to an area where the at least one mobile computing device and the at least one stationary computing device are located using at least one networking protocol;
receiving software modules from the computing entity, each one customized for the at least one mobile computing device receiving the software modules, for establishing the symbiotic relationships between the at least one mobile computing device and the at least one stationary computing device;
running the software modules to interact with the at least one stationary computing device and the computing entity to establish symbiotic relationships that enable performing tasks selected by the at least one mobile computing device.

17. The method of claim 16 wherein the interacting, receiving and running steps are executed automatically upon receiving a trigger selected from a group consisting of: the at least one mobile computing device entering a designated location; an action of a mobile device user; a pre-selected preference of the mobile device user; and a time event.

18. The method of claim 16 wherein the software modules interact over a web services protocol such as SOAP over HTTP.

19. The method of claim 16 wherein the running step further comprises running the software modules to interact according to preset patterns, wherein the preset patterns are determined according to pre-established associations.

20. The method of claim 16 wherein the running step further comprises running the software modules to include mappings of input/output capabilities of the at least one mobile computing device to input/output requirements of the tasks performed on behalf of the mobile device user and to input/output capabilities of other computing devices in the same symbiotic relationship.
